(19) United States
(12) Patent Application Publication
(10) Pub. No.: US 2010/0263802 A1
(43) Pub. Date: Oct. 21, 2010

(54) MOVABLE OFFICE SCREEN SYSTEM

(75) Inventors: Yi-Kai Juan, Taipei City (TW); Wen-Yu Tu, Taipei City (TW)

Correspondence Address: QUINTERO LAW OFFICE, PC, 615 Hampton Dr, Suite A202, Venice, CA, 90291, US

(73) Assignee: NATIONAL TAIWAN UNIVERSITY OF SCIENCE & TECHNOLOGY, Taipei City (TW)

(21) Appl. No.: 12/688,672

(22) Filed: Jan. 15, 2010

(30) Foreign Application Priority Data
Apr. 15, 2009 (TW) TW98112466

(51) Int. Cl. A47G 5/02; E06B 9/00; E06B 9/08; G06F 3/041

(52) U.S. Cl. 160/120; 160/242; 160/127; 345/173

(57) ABSTRACT

A movable office screen system. A main screen unit has a first end and a second end opposite thereto. A first roller blind screen is disposed in the main screen unit and selectively extends to the exterior thereof. At least one roller is connected to the first end of the main screen unit. The main screen unit is supported by the roller and is moved by rolling of the roller.

### CROSS REFERENCE TO RELATED APPLICATIONS

This Application claims priority of Taiwan Patent Application No. 98112466, filed on Apr. 15, 2009, the entirety of which is incorporated by reference herein.

### BACKGROUND OF THE INVENTION

1. Field of the Invention

The invention relates to a movable office screen system, and more particularly to a movable office screen system that can flexibly provide multifunctional operations.

2. Description of the Related Art

Screens are commonly employed in offices for individual privacy and partitioning of working areas. There are many drawbacks existing with conventional office screens, one is weight. Conventional office screens are heavy and cannot be easily moved when partitioning in an office needs to be changed. Moreover, conventional office screens provide limited functions, such as partitioning, and often are not able to meet user demands. Furthermore, conventional office screens provide excessive barriers, preventing mobility and communication among co-warders. Additionally, wiring layout of multiple devices within conventional office screens is often disordered, thereby providing unfavorable walking routes for personnel and a poor appearance. Meanwhile, although the conventional office screens can be repeatedly assembled and disassembled, reuse of the material and structure thereof is poor. Specifically, when the conventional office screens are directly fixed to walls, removal thereof may cause damage to the walls.

Hence, there is a need for a movable office screen system integrated with multiple application devices and flexibly providing multifunctional operations as required.

### BRIEF SUMMARY OF THE INVENTION

A detailed description is given in the following embodiments with reference to the accompanying drawings.

An exemplary embodiment of the invention provides a movable office screen system comprising a main screen unit, a first roller blind screen, and at least one roller. The main screen unit has a first end and a second end opposite thereto. The first roller blind screen is disposed in the main screen unit and selectively extends to the exterior thereof. The roller is connected to the first end of the main screen unit. The main screen unit is supported by the roller and is moved by rolling of the roller.

The movable office screen system further comprises an oil-pressure telescopic device disposed in the main screen unit and connected to the first roller blind screen. The oil-pressure telescopic device selectively extends to the exterior of the main screen unit, fixing the first roller blind screen.

The movable office screen system further comprises a flip-up desk rotatably connected to the main screen unit.

The movable office screen system further comprises a metal panel disposed on the main screen unit and selectively covered by the flip-up desk.

The movable office screen system further comprises a second roller blind screen disposed in the main screen unit. The second roller blind screen selectively extends to the exterior of the main screen unit and is positioned on the flip-up desk.

The extending direction of the second roller blind screen is perpendicular to that of the first roller blind screen.

The movable office screen system further comprises an accommodation compartment formed in the main screen unit.

The movable office screen system further comprises a door plank rotatably connected to the main screen unit and selectively covering the accommodation compartment.

The movable office screen system further comprises a cushioning spring connected between the roller and the first end of the main screen unit.

The movable office screen system further comprises a main controller disposed on the main screen unit.

The main controller comprises a touch screen.

The movable office screen system further comprises an interactive liquid crystal display screen disposed on the main screen unit.

The movable office screen system further comprises a roof connected to the second end of the main screen unit.

The movable office screen system further comprises an illumination device disposed on the roof.

The movable office screen system further comprises a fan disposed on the roof.

The movable office screen system further comprises a speaker disposed on the roof.

The movable office screen system further comprises a projector disposed on the roof.

The movable office screen system further comprises an electronic display panel disposed on the roof.

The movable office screen system further comprises at least one suspension rod and an adaptive power supply track. The suspension rod is connected to the second end of the main screen unit and slidably fits in the adaptive power supply track. The adaptive power supply track supplies electric power to the main screen unit through the suspension rod.

### BRIEF DESCRIPTION OF THE DRAWINGS

The invention can be more fully understood by reading the subsequent detailed description and examples with references made to the accompanying drawings, wherein:

FIG. 1A is a schematic plane view of a movable office screen system of the invention in an operational mode;

FIG. 1B is a schematic left side view of FIG. 1A;

FIG. 1C is a schematic rear view of FIG. 1A;

FIG. 2A is a schematic plane view of the movable office screen system of the invention in another operational mode;

FIG. 2B is a schematic left side view of FIG. 2A;

FIG. 2C is a schematic right side view of FIG. 2A; and

FIG. 3 is a schematic plane view of a roof of the movable office screen system of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

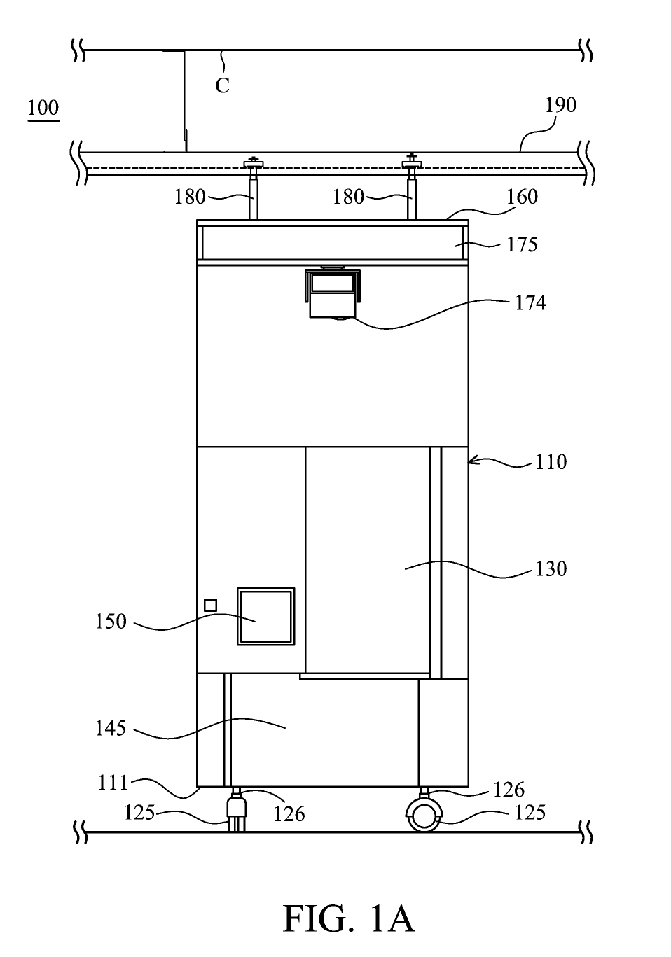

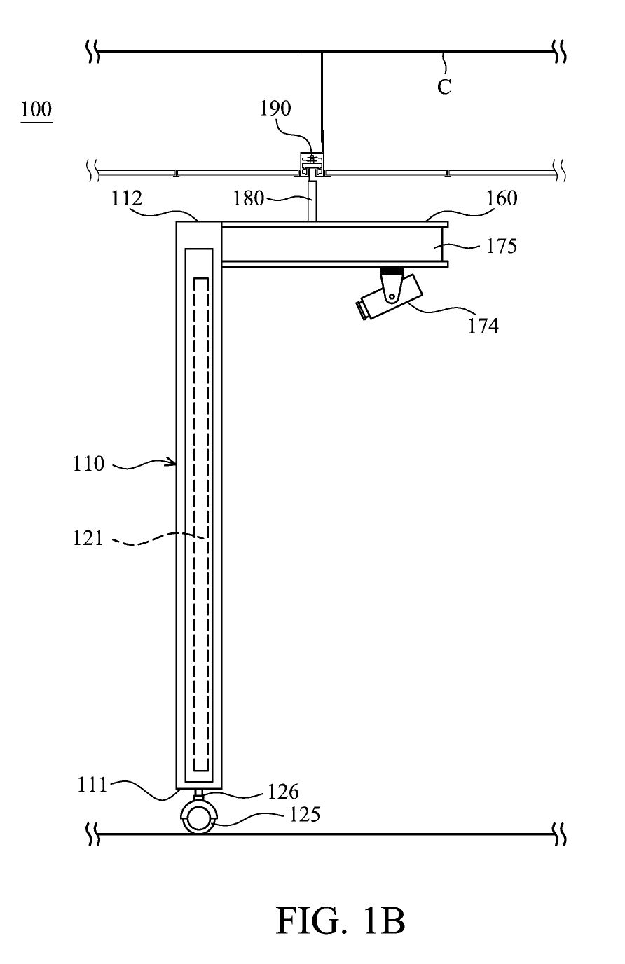

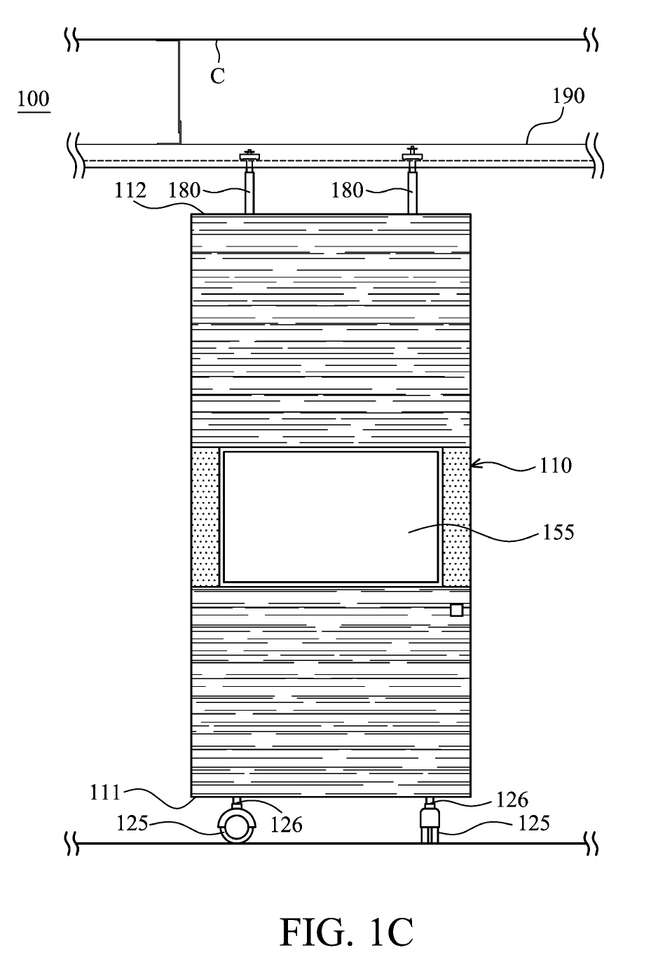

Referring to FIGS. 1A, 1B, 1C, 2A, 2B, 2C, and 3, a movable office screen system 100 comprises a main screen unit 110, a first roller blind screen 121, a second roller blind screen 122, an oil-pressure telescopic device 123, a plurality of rollers 125, a plurality of cushioning springs 126, a flip-up desk 130, a metal panel 135, an accommodation compartment 140, a door plank 145, a main controller 150, an interactive liquid crystal display screen 155, a roof 160, a plurality of illumination devices 171, a fan 172, a speaker 173, a projector 174, an electronic display panel 175, a plurality of suspension rods 180, and an adaptive power supply track 190.

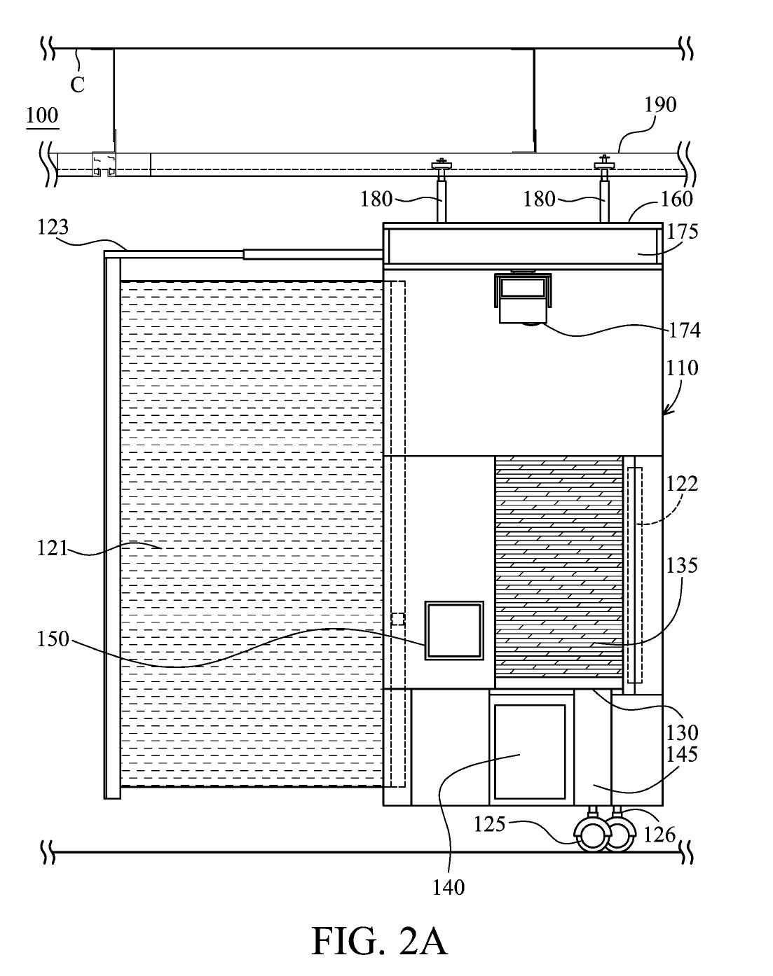

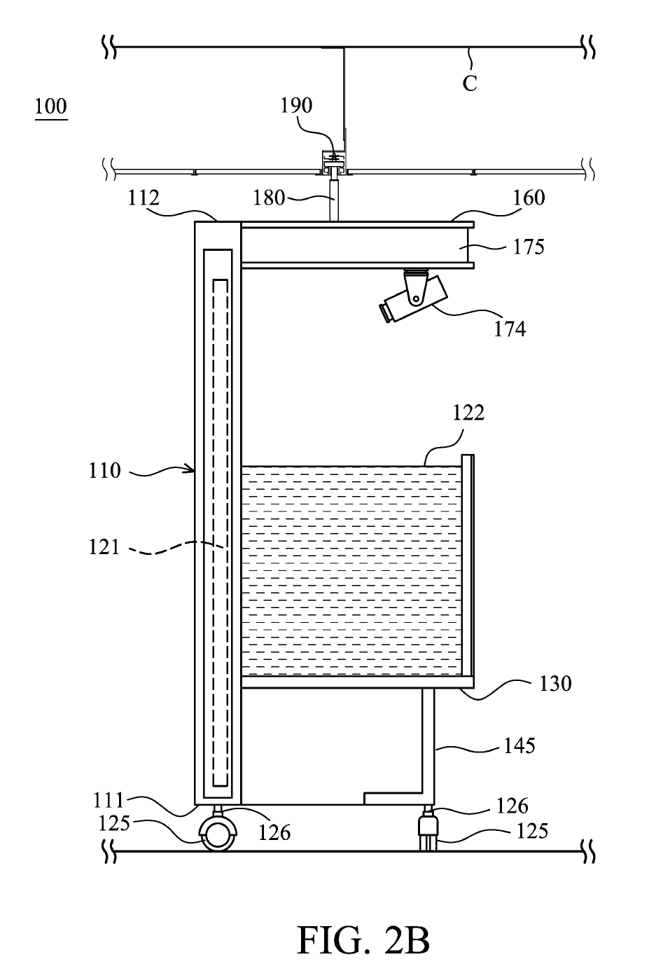

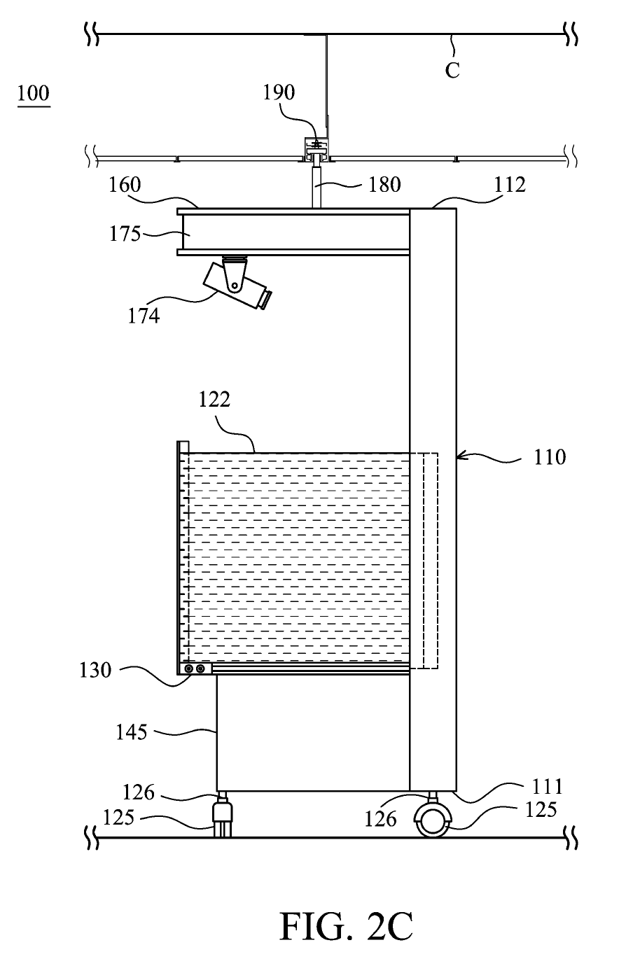

As shown in FIG. 1B and FIG. 2B, the main screen unit 110 has a first end 111 and a second end 112 opposite thereto.

As shown in FIGS. 1B, 2A, and 2B, the first roller blind screen 121 is disposed in the main screen unit 110 and selectively extends to the exterior thereof. Here, after being pulled out of the main screen unit 110, the first roller blind screen 121 can provide functions of defining working areas and serve as a sliding door for a space between multiple main screen units 110. Moreover, patterns on the surface of the first roller blind screen 121 can be designed according to a user's preference or overall interior decoration of an office.

As shown in FIG. 2A, the oil-pressure telescopic device 123 is disposed in the main screen unit 110 and is connected to the first roller blind screen 121. Here, the oil-pressure telescopic device 123 can selectively extend to the exterior of the main screen unit 110, fixing the first roller blind screen 121. Specifically, the oil-pressure telescopic device 123 may be operated with an electric or a manual manner, enabling the first roller blind screen 121 to extend to the exterior of the main screen unit 110 and to be received in the main screen unit 110.

As shown in FIGS. 1A, 1B, 1C, 2A, 2B, 2C, and 3, each cushioning spring 126 is connected between each roller 125 and the first end 111 of the main screen unit 110. Here, the main screen unit 110 is supported by the rollers 125 and is moved by rolling thereof. Specifically, to solve the problem of an uneven level of a floor on which the main screen unit 110 is placed, the cushioning springs 126 absorb and adjust level discrepancy of the floor, ensuring steady movement of the main screen unit 110.

As shown in FIGS. 1A, 2A, 2B, and 2C, the flip-up desk 130 is rotatably connected to the main screen unit 110. Here, to present an aesthetically pleasing appearance, the flip-up desk 130 can be attached to the main screen unit 110 when not used.

As shown in FIG. 2A, the metal panel 135 is disposed on the main screen unit 110 and is selectively covered by the flip-up desk 130. Specifically, when the flip-up desk 130 is unfolded from the main screen unit 110, the metal panel 135 is exposed to the main screen unit 110 and provides auxiliary functions of attaching document sheets with magnets.

As shown in FIGS. 2A, 2B, and 2C, the second roller blind screen 122 is disposed in the main screen unit 110. Here, the second roller blind screen 122 selectively extends to the exterior of the main screen unit 110 and is positioned on the flip-up desk 130. Specifically, after the flip-up desk 130 is unfolded from the main screen unit 110, the second roller blind screen 122 can be dragged from the interior of the main screen unit 110 and positioned in a specific position by the flip-up desk 130. In this embodiment, the second roller blind screen 122 can provide functions of a shelter from the front of the flip-up desk 130, thereby promoting personal privacy. Moreover, the second roller blind screen 122 may serve as a background screen for a projector. Additionally, in this embodiment, the extending direction of the second roller blind screen 122 is perpendicular to that of the first roller blind screen 121.

As shown in FIG. 2A, the accommodation compartment 140 is formed in the main screen unit 110. Here, the accommodation compartment 140 can accommodate facilities such as a computer host.

As shown in FIGS. 1A, 2A, 2B, and 2C, the door plank 145 is rotatably connected to the main screen unit 110 and selectively covers the accommodation compartment 140, providing an aesthetically pleasing effect for the main screen unit 110.

As shown in FIG. 1A and FIG. 2A, the main controller 150 is disposed on (the front surface of) the main screen unit 110. In this embodiment, the main controller 150 may be a touch screen providing functions of personnel login, manipulation of related electronic devices, and real-time video communication.

As shown in FIG. 1C, the interactive liquid crystal display screen 155 is disposed on (the rear surface of) the main screen unit 110. Here, the interactive liquid crystal display screen 155 can provide functions of displaying business introduction information, products, personal data, personal hobbies, and links to a personal web page. For example, when a user leaves his seat, the interactive liquid crystal display screen 155 can provide functions of displaying interactive messages. Moreover, the user can construct a virtual fish tank, a virtual pet and virtual planting for recreation and decoration. Additionally, the user can retrieve his own settings after login using the interactive liquid crystal display screen 155.

As shown in FIGS. 1A, 1B, 2A, 2B, and 2C, the roof 160 is connected to the second end 112 of the main screen unit 110.

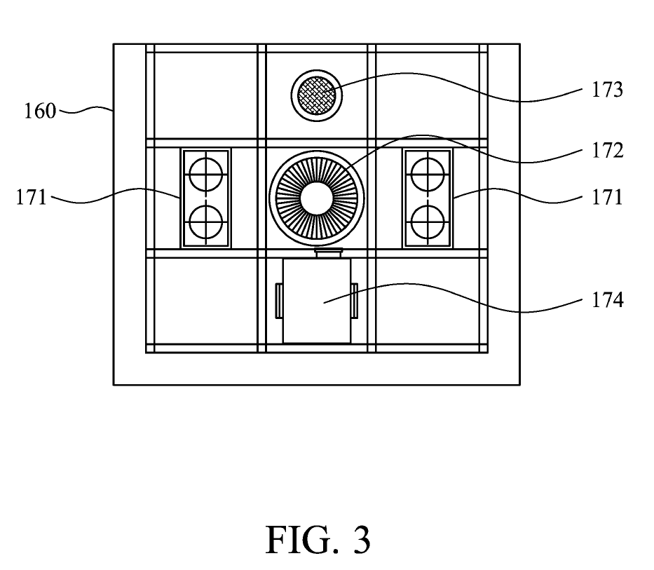

As shown in FIG. 3, the illumination devices 171, fan 172, speaker 173, and projector 174 are disposed on the roof 160. Here, the illumination devices 171, fan 172, speaker 173, and projector 174 can be manipulated using the main controller 150 (shown in FIG. 1A and FIG. 2A), providing functions of local illumination, ventilation, sound effects, and image playing, and further providing an enhanced working environment quality. Moreover, as the second roller blind screen 122 may serve as a background screen, images from the projector 174 can be directly projected thereon.

As shown in FIGS. 1A, 1B, 2A, 2B, and 2C, the electronic display panel 175 is disposed on the roof 160. Preferably, the electronic display panel 175 surrounds the periphery of the roof 160, such that better visibility of the electronic display panel 175 can be provided. In this embodiment, the user can reveal a working status, such as “busy”, “out for meal”, or “on telephone”, on the electronic display panel 175 through the main controller 150, such that others can easily acquire the user's working status. Moreover, the electronic display panel 175 can use light-emitting diodes as a light source, achieving an energy-saving effect.

As shown in FIGS. 1A, 1B, 1C, 2A, 2B, and 2C, the adaptive power supply track 190 may be fixed to a ceiling C in the office. The suspension rods 180 are connected to the second end 112 of the main screen unit 110 and slidably fit in the adaptive power supply track 190. Here, the adaptive power supply track 190 can supply electric power to the main screen unit 110 through the suspension rods 180, and the electric power can then be supplied to all the electric devices disposed in the main screen unit 110. Specifically, as the electric power supplied to the electric devices disposed in the main screen unit 110 are provided by the adaptive power supply track 190 disposed above the main screen unit 110, the main screen unit 110 is not restricted by power lines and can be arbitrarily moved. Further, the adaptive power supply track 190 may be a two-way adaptive track, enabling the main screen unit 110 to arbitrarily move.

Moreover, the movable office screen system 100 is not limited to having only a main screen unit 110 and a roof 160. Namely, the movable office screen system 100 may selectively comprise a plurality of main screen units 110 and a plurality of roofs 160. The main screen units 110 and roofs 160 can be, as required, connected to each other to form an enlarged working area, thus benefiting teamwork.

Accordingly, the disclosed movable office screen system can overcome undesirable conventional office impressions of inflexible working areas and present a distinctive character for each independent working area. Moreover, the disclosed movable office screen system enhances characteristics of flexibility, mobility, social friendliness, and personnel interaction. Additionally, in the disclosed movable office screen system, wiring of the facilities is hidden in the main screen unit and is connected to the adaptive power supply track through the suspension rods. Thus, no socket or plug is required to exist on the floors or walls in the office, providing a neat and tidy working environment. In addition, as the disclosed movable office screen system can perform multiple independent business operations with an integrated manner, required leasing space and office rent may be reduced. Furthermore, the disclosed movable office screen system can be provided with expandable applicability. For example, the disclosed movable office screen system can be applied outdoors, such as at a rapid transit station or a park, to provide functions of supporting temporary business operations, thus providing a mobile office.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A movable office screen system, comprising:
a main screen unit having a first end and a second end opposite thereto;
a first roller blind screen disposed in the main screen unit and selectively extending to the exterior thereof; and
at least one roller connected to the first end of the main screen unit, wherein the main screen unit is supported by the roller and is moved by rolling of the roller.

2. The movable office screen system as claimed in claim 1, further comprising an oil-pressure telescopic device disposed in the main screen unit and connected to the first roller blind screen, wherein the oil-pressure telescopic device selectively extends to the exterior of the main screen unit, fixing the first roller blind screen.

3. The movable office screen system as claimed in claim 1, further comprising a flip-up desk rotatably connected to the main screen unit.

4. The movable office screen system as claimed in claim 3, further comprising a metal panel disposed on the main screen unit and selectively covered by the flip-up desk.

5. The movable office screen system as claimed in claim 3, further comprising a second roller blind screen disposed in the main screen unit, wherein the second roller blind screen selectively extends to the exterior of the main screen unit and is positioned on the flip-up desk.

6. The movable office screen system as claimed in claim 5, wherein the extending direction of the second roller blind screen is perpendicular to that of the first roller blind screen.

7. The movable office screen system as claimed in claim 1, further comprising an accommodation compartment formed in the main screen unit.

8. The movable office screen system as claimed in claim 7, further comprising a door plank rotatably connected to the main screen unit and selectively covering the accommodation compartment.

9. The movable office screen system as claimed in claim 1, further comprising a cushioning spring connected between the roller and the first end of the main screen unit.

10. The movable office screen system as claimed in claim 1, further comprising a main controller disposed on the main screen unit.

11. The movable office screen system as claimed in claim 10, wherein the main controller comprises a touch screen.

12. The movable office screen system as claimed in claim 1, further comprising an interactive liquid crystal display screen disposed on the main screen unit.

13. The movable office screen system as claimed in claim 1, further comprising a roof connected to the second end of the main screen unit.

14. The movable office screen system as claimed in claim 13, further comprising an illumination device disposed on the roof.

15. The movable office screen system as claimed in claim 13, further comprising a fan disposed on the roof.

16. The movable office screen system as claimed in claim 13, further comprising a speaker disposed on the roof.

17. The movable office screen system as claimed in claim 13, further comprising a projector disposed on the roof.

18. The movable office screen system as claimed in claim 13, further comprising an electronic display panel disposed on the roof.

19. The movable office screen system as claimed in claim 1, further comprising at least one suspension rod and an adaptive power supply track, wherein the suspension rod is connected to the second end of the main screen unit and slidably fits in the adaptive power supply track, and the adaptive power supply track supplies electric power to the main screen unit through the suspension rod.
